(19) United States
(12) Patent Application Publication
(10) Pub. No.: US 2026/0330851 A1
(43) Pub. Date: Oct. 22, 2026

(54) A METHOD FOR DISTINGUISHING USER FEEDBACK ON AN IMAGE

(71) Applicant: SIGNIFY HOLDING B.V., EINDHOVEN (NL)

(72) Inventor: PETER DEIXLER, ARLINGTON, MA (US)

(21) Appl. No.: 19/107,740

(22) PCT Filed: Aug. 18, 2023
(86) PCT No.: PCT/EP2023/072776

§ 371 Date: Feb. 28, 2025

Related U.S. Application Data
(60) Provisional application No. 63/402,178, filed on Aug. 30, 2022.

(30) Foreign Application Priority Data
Sep. 9, 2022 (EP) 22194776.5

(51) Int. Cl. G06V 20/70; H05B 47/175

(52) U.S. Cl. CPC G06V 20/70; H05B 47/197; H05B 47/1975

(57) ABSTRACT

A method for distinguishing user feedback on an image is disclosed. The method comprises providing an image of a scene comprising an environment, a luminaire design of a luminaire and a light effect of the luminaire in the environment, analyzing the image, determining a first saliency value for the luminaire design in the image, determining a second saliency value for the light effect in the image, wherein the second saliency value is different from the first saliency value. The method further comprises receiving the user feedback on the image and associating the user feedback with the luminaire design and/or the light effect based on the first and second saliency values.

### FIELD OF THE INVENTION

The invention relates to a method for distinguishing user feedback on an image. The invention further relates to a computer program and controller for distinguishing user feedback on an image.

### BACKGROUND

With the increase in the availability of luminaire designs comes the challenge of identifying and providing users with personalized recommendations. In recent years this personalization has been focused on selecting a design of a luminaire that matches the aesthetic taste and wishes of the user. As one example, in patent application WO 2014064634, a method is proposed that assists a user in selecting a lighting device based on a scene and light effect selected by the user. Patent application WO 2014087274 relates to assisting a user in selecting a lighting device design through receiving an image of a scene and analyzing this image in order to select or generate a lighting device design. The user may be first presented a light effect as part of a scene (e.g., a broad beam down light from the center of the ceiling applied to a living room), allowing the user to choose the light effect prior to choosing the lighting device design.

### SUMMARY OF THE INVENTION

The inventors have realized that when a user is presented an image of a luminaire design of a luminaire and its effect in an environment, the user may assess the image as attractive based on a combination of both the luminaire design, e.g., luminaire shape, texture, material of the housing of the luminaire, etc., and the administered light effect of the luminaire in the environment, e.g., administered spatial spectrum distribution, time-dynamics of the effect, light intensity, beam shape, etc. The user however may not be able to verbally explain the rationale behind such preference. As a result, the preference (appraisal or dislike feedback) of the user towards the image may be directed to/associated with either the luminaire design, the light effect of the luminaire design on the environment, or a combination of both. For example, a user's rejection of an image of a scene comprising an environment, a luminaire design of a luminaire and its light effect, may be due to the user appraising the luminaire design (or specific aspects of the luminaire design) but disliking the light effect of the luminaire on the environment depicted in the image. Similarly, the user's rejection of the image may be due to the user appraising the light effect but disliking the material of the luminaire, etc.

It is an object to improve the learning of preferences of the user.

According to a first aspect, the object is achieved by a method for distinguishing user feedback on an image, the method comprising the steps of:
providing an image of a scene comprising an environment, a luminaire design of a luminaire, and a light effect of the luminaire in the environment;
analyzing the image;
determining a first saliency value for the luminaire design in the image;
determining a second saliency value for the light effect in the image;
receiving the user feedback on the image;
associating the user feedback to the luminaire design and/or the light effect based on the first and second saliency values.

An image of a scene comprising an environment, a luminaire design of a luminaire, and a light effect of the luminaire in the environment, is analyzed to determine a first saliency value (saliency level) for the luminaire design and a second saliency value (saliency level) for the light effect of the luminaire. The second saliency value may be different from the first saliency value. In the context of this disclosure, a saliency value may refer to a value indicative of the noticeability (importance/prominence) of the luminaire design or light effect, respectively, in the image. For example, a first image of a luminaire design where the light effect of the luminaire design is negligible, e.g., image of a luminaire design during daytime where only ambient lighting is present, has a low second saliency value for the light effect. On the contrary, a second image of the same luminaire design in the same environment but during the evening, where the light effect of the luminaire design is prominent (highly visible) has a high second saliency value for the light effect.

By providing the user with an image of a scene comprising an environment, a luminaire design of a luminaire, and a light effect of the luminaire in the environment, analyzing the image to determine a first and a second saliency level for the luminaire design and light effect respectively, the feedback of the user can be associated to the luminaire design and/or the light effect based on the first and second saliency values. The method thereby allows to distinguish whether the feedback of the user is directed to the luminaire design or to the light effect without explicitly asking the user (that may also not be able to explain the rationale behind the like/dislike feedback). This is beneficial because it improves the learning of user preferences.

The step of associating the user feedback may comprise associating, if the second saliency value is greater than the first saliency value, the user feedback with the light effect and associating, if the first saliency value is greater than the second saliency value, the user feedback with the luminaire design. This provides a simple approach to determine whether the feedback is directed to the luminaire design or the light effect.

The step of associating the user feedback may comprise associating the user feedback with the luminaire design as a function of the first saliency level and associating the user feedback with the light effect as a function of the second saliency value. In some cases, the feedback of the user may be related to both the luminaire design and the light effect. In such cases (but not limited to these cases), the method may comprise associating the user feedback with the luminaire design as a function of the first saliency level and associating the user feedback with the light effect as a function of the second saliency value. For example, the method may comprise assigning a likelihood to an association of the feedback with the luminaire design and with the light effect. The likelihood may comprise probabilities or weights of feedback being assigned to the luminaire design/light effect. The likelihood may comprise relative weights or relative probabilities. The likelihood may be based on a function of the saliency values, such that the likelihood that the feedback is associated with the luminaire design/light effect is proportional (analogous) to the light effect saliency value of the luminaire design/light effect, respectively.

The method may further comprise generating, using a machine learning model, a first text description of preferences of the user for the luminaire design and a second text description of preferences of the user for the light effect based on the associated feedback, and outputting the generated first and second text descriptions. The generated first and second text descriptions may be outputted to a user interface for presentation to the user, or for example as input to a further machine learning model. The machine learning model may have been trained using labeled instances of images with associated user feedback as input. The machine learning model may for example be a layered combination of a Convolution Neural Network (CNN) responsible for image feature extraction and a Long short-term memory model (LSTM) which generates the text descriptions. An example of such a machine learning model may be a Generative Pre-trained Transformer 3 (GPT-3). In this way, the user may be informed on his/her personal preferences on the different aspects of a luminaire, namely, the luminaire design and the light effect of the luminaire in the environment. Optionally, the user may provide feedback on the text descriptions of preferences (whether (s)he considers the text descriptions of preferences accurate, etc.). In addition, the text descriptions can be fed into a database comprising the feedback from many different users. Based on statistical analysis of the text descriptions, the system may automatically generate different user types, which are sharing similar design preferences. During inference, these user types can be leveraged to speed up the convergence of a new user to an agreeable luminaire lighting design.

The second saliency value may be determined based on the spread of the light effect in the environment. The image may be analyzed to determine the level of spread (spatial distribution) of light in the environment. The level of visual saliency (visual saliency value) of the light effect may depend on the level of spread, i.e., the spatial distribution of the light effect in the image. In other words, the second visual saliency value may depend on how much the light effect of the luminaire influences the surrounding of the luminaire design in the image. The image may be analyzed to determine the number of luminaires in the image. The second saliency value may also depend on whether there is just a single luminaire visible in the image or whether there is more than one luminaire present which also generate their own light effects in the image. Similarly, the first saliency value may depend on the spatial distribution of the luminaire design in the image. In other words, how much space the luminaire design occupies in the image.

The second saliency value may be determined based on characteristics of the environment. For example, the image may be analyzed to determine the light effect distribution in the image. For example, an abstract environment with a uniform light effect distribution (light effect spread uniformly around the luminaire design in the image) may have a lower second saliency value compared to a detailed environment, i.e., an environment with a plurality of elements wherein the light effect integrates with the elements of the environment. The first and second saliency values may further depend on the saturation of the luminaire design \light effect, respectively, in the image. The first and second saliency values may further depend on whether there is just a single luminaire visible in the image or whether there are more than one luminaire present which also generate their own light effects in the image. If there are multiple luminaires present in the image, the saliency of the lighting effect is more prominent.

The feedback of the user may comprise a text input. For example, a text input from the user may be received via a user interface. As a particular example, a user interface may be implemented by way of one or more web pages displayed by a user device by way of a web browser software program. Additionally, and/or alternatively, the user feedback may be in the form of a voice command as well.

In an example, the user feedback may be input data indicative of physiological changes of the user (indicative of an image appraisal or dislike). For example, a heart rate and/or breathing rate of the user may be received, and the user feedback may be determined based on measured changes in the heart rate and/or breathing rate of the user. In an advanced example, an EEG (electroencephalogram), EOG (electrooculogram), EDA (electrodermal activity), PPG (photoplethysmogram), EMG (electromyography activity), etc., of the user may be received, for example through an augmented reality headset, wristband, etc., and the user feedback may be determined based on changes on such measurements of the user.

The feedback of the user may further comprise a gesture. For example, a gesture input, such as a finger swipe or a hand motion, as for example sensed using an optical or capacitive sensor, may be received from the user.

In some cases, it would be desirable that the user may be provided (recommended) images of luminaire designs that are outside of a listing or catalog of existing luminaires. The method may further comprise generating, using a generative-AI machine learning model, a synthesized image of a scene comprising a further (synthesized) luminaire design of a further luminaire and a light effect based on the associated feedback. In an embodiment, the generative-AI machine learning model is a text-conditional generative adversarial network conditioned to generate the synthesized image based on the generated text descriptions of user preferences on the luminaire design and the associated light effect.

In another example, a text-to-image diffusion model, such as Imagen, DALL-E 2, etc., may be used to generate the synthesized image using the text descriptions as an input. Thereby, there is provided a method that automatically designs and generates new luminaire designs (with respective light effects) that better match the taste and preferences of the user.

The method may further comprise:
analyzing the synthesized image;
determining a (further) first saliency value for the luminaire design in the synthesized image;
determining a (further)second saliency value for the light effect in the synthesized image;
receiving the user feedback on the synthesized image;
associating the user feedback to the luminaire design and/or the light effect based on the first and second saliency values.

This is beneficial as the user feedback associations may in turn trigger re-iterating over the previous step of providing a further synthesized image. This allows to provide a further synthesized image closer to the taste and preference of the user (speeds up the convergence to a preferred luminaire design for the user).

The method may further comprise generating a specification for the further luminaire design and a specification for the light effect, and outputting the specifications to a system or service for generating (or manufacturing) the further luminaire design. For example, the specification for the light effect may comprise, a shape of the light effect, a pattern of the light effect, one or more colors of the light effect, and/or a location of a feature of the light effect. The specification for the luminaire design may comprise a shape of the luminaire design, a size of the luminaire design, a number of lumens based on the light effect, a number of light emitters and a type of the light emitters based on the number of lumens, a number of drivers and a type of the drivers based on the number and type of light emitters. After outputting the system specifications for generating the further luminaire design, the user may place an order for the further (synthesized) luminaire design, or print the design via a 3D printer.

According to a second aspect, the object is achieved by a computer program product for a computing device, the computer program product comprising computer program code to perform any of the above-mentioned methods when the computer program product is run on a processing unit of the computing device. Such a computer program product may be executed on a computer, such as a personal computer or a laptop, or a smart phone or other computing device.

According to a third aspect, the object is achieved by a controller for distinguishing user feedback on an image configured to:
provide an image of a scene comprising an environment, a luminaire design, and a light effect of the luminaire in the environment;
analyze the image;
determine a first saliency value for the luminaire design in the image;
determine a second saliency value for the light effect in the image, wherein the second saliency value is different from the first saliency value,
receive the user feedback on the image;
associate the user feedback to the luminaire design and/or the light effect based on the first and second saliency values.

It should be understood that the computer program product and the controller may have similar and/or identical embodiments and advantages as the above-mentioned methods.

### BRIEF DESCRIPTION OF THE DRAWINGS

The above, as well as additional objects, features and advantages of the disclosed systems, devices and methods will be better understood through the following illustrative and non-limiting detailed description of embodiments of devices and methods, with reference to the appended drawings, in which:

FIG. 1 shows schematically an example of an image of a scene comprising an environment, a luminaire design of a luminaire and a light effect of the luminaire in the environment;

FIG. 2 shows schematically a controller configured to provide an image of a scene comprising an environment, a luminaire design of a luminaire, and a light effect of the luminaire in the environment to a user;

FIG. 3 shows schematically a flowchart illustrating an embodiment of a method for distinguishing user feedback on an image;

FIG. 4 shows schematically an example of an image of a scene comprising an environment, a luminaire design of a luminaire and a light effect of the luminaire in the environment.

All the figures are schematic, not necessarily to scale, and generally only show parts which are necessary in order to elucidate the invention, wherein other parts may be omitted or merely suggested.

### DETAILED DESCRIPTION

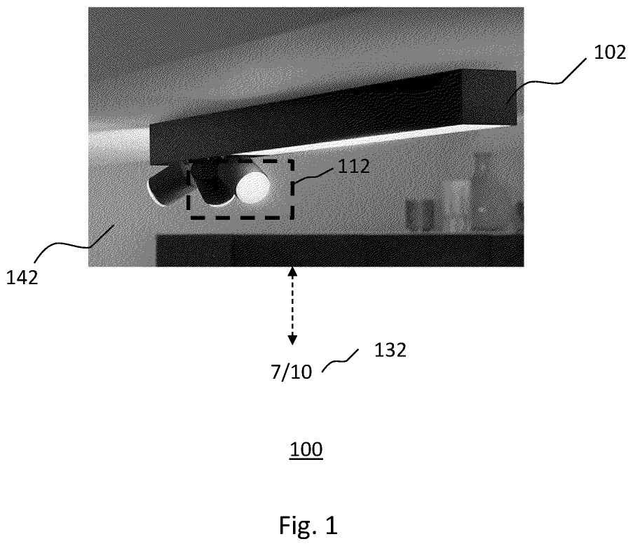

FIG. 1 shows an example of an image 100 of a scene comprising an environment 142, a luminaire design 102 of a luminaire and a light effect 112 of the luminaire in the environment. The environment 102 refers to the surroundings of the luminaire design. The environment 102 may be any type of home environment, e.g., a kitchen, a living-room, a bathroom, etc., a commercial environment, e.g., a factory, a restaurant, an office, etc., or a plain background environment, e.g., plain white, or other color font.

The luminaire design 102 comprises at least one light source or lamp (not shown), such as an LED-based lamp, gas-discharge lamp or filament bulb, etc., optionally with an associated support, casing or other such housing. The luminaire design 102 may take any of a variety of forms, e.g., a ceiling mounted lighting device, a wall-mounted lighting device, a wall washer, a free-standing lighting device, a LED strip, a LED bulb, a laser lighting fixture, and ultra-thin OLED luminaire etc., and any size, shape, material or color. In this exemplary figure, the luminaire design 102 is a ceiling luminaire. The image 100 may contain any number of luminaires.

The light effect 112 of the luminaire in the environment refers to the light output of the at least one light source or lamp and how the light output influences the surrounding of the luminaire, the environment. The light effect 112 may comprise a color or color temperature of the light source, an illumination intensity (brightness), a beam width, beam direction, and other parameters of the one or more light sources of the luminaire design 102. The image may be part of video and the light effect 112 may comprise a dynamic light scene, wherein the dynamic light scene may comprise light effects which change with time.

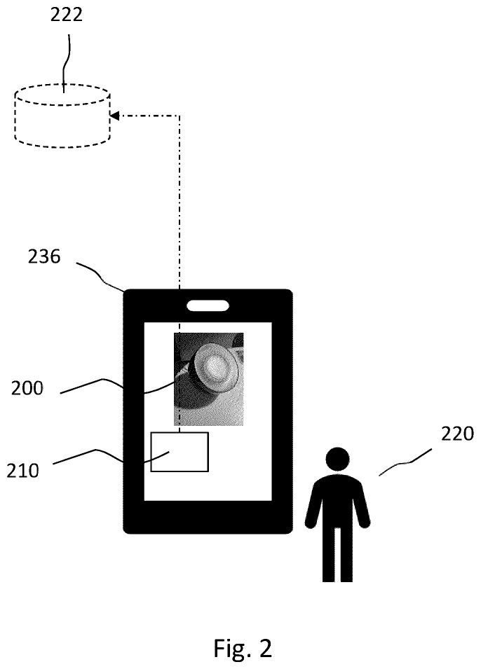

FIG. 2 shows schematically and exemplary a controller 210 configured to provide an image 200 (e.g., the image of FIG. 1) of a scene comprising an environment, a luminaire design of a luminaire, and a light effect of the luminaire in the environment to the user 220. The controller 210 may be implemented in a device, such as a desktop computer or a portable terminal such as a laptop, tablet or smartphone. The controller 210 may alternatively be implemented in the cloud, for instance as a server that is accessible via the internet. The image 200 is provided to the user 220, for example via a user interface on a device such as a laptop, tablet or smartphone 236. Alternatively, the image 200 may be shown as a video to the user 220. Alternatively, the image 200 may be shown via an AR/VR headset to the user 220. The controller 210 is configured to analyze the image 200 and determine a first saliency value for the luminaire design in the image and a second saliency value for the light effect in the image based on the analysis. The controller 210 may be configured to apply image analysis techniques to recognize the luminaire (and therewith its design) and the light effect of the luminaire in the image 200. Image analysis techniques for recognizing objects and features in the image are known in the art and will therefore not be discussed in detail.

The second saliency value may, for example, be determined based on the spread of the light effect 112 in the environment 142. That is, the second saliency value may be proportional to the spatial distribution of the light effect 112 in the image 100. In other words, the second visual saliency value may depend on how much space, e.g., a number of pixels, the light effect 112 of the luminaire occupies in the image 100. Similarly, the first saliency value may depend on the spatial distribution of the luminaire design 102 in the image 100. In other words, the first saliency value may depend on how much space, e.g., a number of pixels, the luminaire design 102 occupies in the image 100. In exemplary FIG. 1, the first (visual) saliency value is higher than the second (visual) saliency value, as the luminaire design 102 occupies most of the image 100. The second saliency value may be further analyzed to include saliency values for design aspects of the luminaire design. For example, a saliency value for the shape, material, style, etc., of the luminaire design 102.

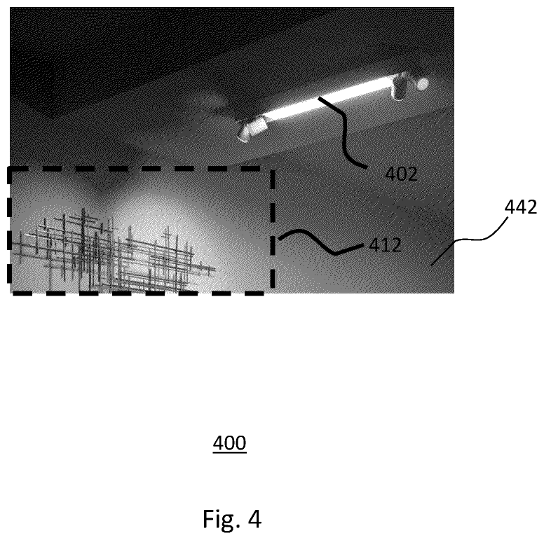

FIG. 4 shows an example of an image 400 of a scene comprising an environment 442, a luminaire design 402 of a luminaire and a light effect 412 of the luminaire in the environment. In exemplary FIG. 4, the first (visual) saliency value for the luminaire design is lower than the second (visual) saliency value for the light effect, as the light effect 412 occupies more space (higher number of pixels) than the luminaire design 402 in the image 400. The second saliency value may be determined based on characteristics of the environment. For example, an abstract environment with a uniform light effect distribution (light effect spread uniformly around the luminaire design in the image, for example the environment 142 in image 100) may have a lower second saliency value compared to a detailed environment, i.e., environment with a plurality of elements wherein the light effect integrates with the elements of the environment, for example as the environment 442 in image 400. The first and second saliency values may further depend on the saturation of the luminaire design\light effect respectively in the image.

The second saliency value may further depend on the color contrast of the light effect. For example, an image with high color contrast of the light effect may have a higher saliency value for the light effect than an image where the color (color temperature) of the light effect is homogeneous.

Additionally, and or alternatively, saliency algorithms for image saliency detection, e. g., GrabCut algorithm, may be used for automatic extraction of the first and second saliency values in an image.

Referring back to FIG. 1, a feedback 132 on the image 200 is received from the user 220. The feedback 132 may comprise a user rating scale, e.g., numeric rating scale like 1-10 rating scale, a binary rating scale (user rates positively or negatively the image), verbal rating scale, actuating at least one actuator, e.g., a like/dislike button on a user's mobile device 236 to indicate his/her preference, the user may move his\her fingers (to swipe) across a screen to indicate positive/negative feedback depending on the direction of the movement, etc. Additionally, and/or alternatively, the feedback 132 may comprise input data indicative of physiological changes of the user 220. For example, a heart rate or breathing rate of the user 220 may be received by the controller 210, and the user feedback 132 may be determined based on measured changes in the heart rate, sweating rate or breathing rate of the user 220. In an advance example, an EEG of the user 220 may be received by the controller 210, and the user feedback 132 may be determined based on changes on the EEG measurements of the user 220.

The controller 210 may be configured to, based on the condition, that if the first saliency value of the light effect is greater than the second saliency value of the luminaire design, associate the feedback 132 to the light effect 112. Similarly, if the first saliency value of the luminaire design is greater than the second saliency value of the light effect, the feedback 132 is associated to the luminaire design 102. Alternatively, the controller 210 may be configured to associate the user feedback 132 with the luminaire design 102 as a function of the first saliency level and associate the user feedback 132 with the light effect 112 as a function of the second saliency value. For example, a likelihood may be assigned to an association of the feedback with the luminaire design and with the light effect; wherein the likelihood that the feedback 132 is associated with the light effect (luminaire design) is proportional to the saliency values of the light effect (luminaire design respectively). The controller may further comprise a memory 222 which may be arranged for storing, for example the feedback of the user.

The controller 210 may further be optionally configured to generate using a machine learning model a first text description of preferences of the user for the luminaire design 102 and a second text description of preferences of the user for the light effect 112 based on the associated feedback 132. In an example, a first text description may be in the form of “Oval-shaped pendant luminaire design”. In another example, a second text description may be in the form of “Homogeneous distributed blue light effect”, etc. The machine learning model may have been trained using labeled instances of images with associated user feedback as input. Computer Vision machine learning models, such as a convolution neural networks, may be used to recognize features in the image, e.g., a shape of a luminaire design, etc., while, Natural Language Processing, e.g., recurrent neural networks like LSTMs, may be used to generate the text descriptions of the images that the user finds attractive. The generated text descriptions may be outputted to the user 220, for example, on the user's mobile device 236, for instance via a display, an AR/VR headset or a voice interface.

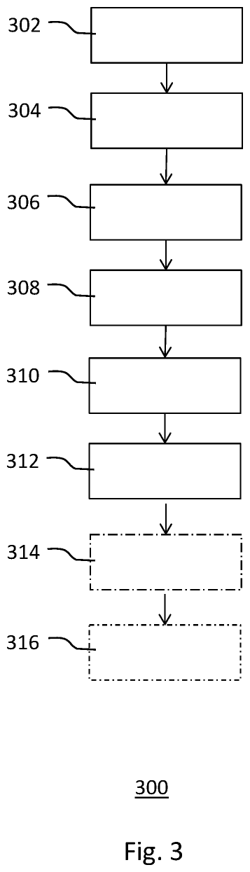

FIG. 3 shows schematically and exemplary a flowchart illustrating an embodiment of a method 300 for distinguishing user feedback on an image, the method comprising the steps of:
providing 302 by the controller 210 an image 100 of a scene comprising an environment 142, a luminaire design 102 of a luminaire, and a light effect 112 of the luminaire in the environment;
analyzing 304 the image 100 by the controller 210;
determining 306, by the controller 210, a first saliency value for the luminaire design in the image;
determining 308, by the controller 210, a second saliency value for the light effect in the image, wherein the second saliency value is different from the first saliency value,
receiving 310, by the controller 210, a user feedback 132 on the image 100, and
associating 312, by the controller 210, the user feedback 132 to the luminaire design 102 and/or the light effect 112 based on the first and second saliency values.

The method 300 may comprise generating 314, using a generative-AI machine learning model, a synthesized image of a scene comprising a further luminaire design and a light effect based on the associated feedback. For example, a text Conditioned Generative Adversarial Network, e.g., TAC-GAN model, may be used to synthesize an image from a text description by conditioning the generated synthesized image on the text description. In another example, a text-to-image diffusion model, such as Imagen, DALL-E 2, etc., may be used to generate the synthesized image using the text description as an input.

Such generative-AI (language) models are known in the state-of-art and will therefore not be further discussed.

The method 300 may further comprise repeating the steps 302 to 312 for the synthesized image.

The method 300 may further comprise generating 316 a specification for the further luminaire design and a specification for the light effect, and outputting 318 the specifications to a system or service for generating (or manufacturing) the further luminaire design. After outputting the system specifications for generating the further luminaire design, the user may place an order for the further (synthesized) luminaire design or print the design via a 3D printer.

The method 300 may be executed by computer program code of a computer program product when the computer program product is run on a processing unit of a computing device, such as the controller 210.

It should be noted that the above-mentioned embodiments illustrate rather than limit the invention, and that those skilled in the art will be able to design many alternative embodiments without departing from the scope of the appended claims.

In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer or processing unit. In the device claim enumerating several means, several of these means may be embodied by one and the same item of hardware. The mere fact that certain measures are recited in mutually different dependent claims does not indicate that a combination of these measures cannot be used to advantage.

Aspects of the invention may be implemented in a computer program product, which may be a collection of computer program instructions stored on a computer readable storage device which may be executed by a computer. The instructions of the present invention may be in any interpretable or executable code mechanism, including but not limited to scripts, interpretable programs, dynamic link libraries (DLLs) or Java classes. The instructions can be provided as complete executable programs, partial executable programs, as modifications to existing programs (e.g. updates) or extensions for existing programs (e.g. plugins). Moreover, parts of the processing of the present invention may be distributed over multiple computers or processors or even the ‘cloud’.

Storage media suitable for storing computer program instructions include all forms of nonvolatile memory, including but not limited to EPROM, EEPROM and flash memory devices, magnetic disks such as the internal and external hard disk drives, removable disks and CD-ROM disks. The computer program product may be distributed on such a storage medium, or may be offered for download through HTTP, FTP, email or through a server connected to a network such as the Internet.

1. A method for distinguishing whether user feedback on an image is associated with a luminaire design of a luminaire and/or a light effect of the luminaire, the method comprising the steps of:
providing an image of a scene, said image comprising an environment, the luminaire, said luminaire having the luminaire design and the light effect of the luminaire in the environment;
analyzing the image for (i) determining a first saliency value for the luminaire design in the image and (ii) determining a second saliency value for the light effect in the image, wherein the second saliency value is different from the first saliency value;
receiving the user feedback on the image;
associating the user feedback with the luminaire design and/or the light effect based on the first and second saliency values.

2. The method according to claim 1, wherein the method further comprises:
generating, using a machine-learning model, a first text description of preferences of the user for the luminaire design and a second text description of preferences of the user for the light effect based on the associated user feedback;
outputting the generated first and second text descriptions.

3. The method according to claim 1, wherein the step of associating the user feedback comprises associating, if the second saliency value is greater than the first saliency value, the user feedback with the light effect and associating, if the first saliency value is greater than the second saliency value, the user feedback with the luminaire design.

4. The method according to claim 1, wherein the step of associating the user feedback comprises associating the user feedback with the luminaire design as a function of the first saliency level and associating the user feedback with the light effect as a function of the second saliency value.

5. The method according to claim 1, wherein the step of analyzing the image comprises analyzing the image to determine a spatial distribution of the light effect and a spatial distribution of the luminaire design in the image, said spatial distribution of the light effect being indicative of a space the light effect occupies in the image and said spatial distribution of the luminaire design being indicative of a space the luminaire design occupies in the image and wherein the step of determining the first and second saliency values comprises determining the first and second saliency values based on the spatial distribution of the luminaire design and the spatial distribution of the light effect in the environment, respectively.

6. The method according to claim 1, wherein the step of analyzing the image comprises analyzing the image to determine characteristics of the environment, and wherein the step of determining the first and second saliency values comprises determining the first and second saliency values based on the characteristics of the environment.

7. The method according to claim 1, wherein the step of receiving the user feedback comprises receiving a text and/or voice input from the user.

8. The method according to claim 1, wherein the step of receiving the user feedback comprises receiving input indicative of physiological changes of the user.

9. The method according to claim 1, wherein the step of receiving the user feedback comprises receiving a gesture input from the user.

10. The method according to claim 1, wherein the method further comprises generating, using a generative-AI machine learning model, and based on the associated user feedback, a synthesized image of the scene comprising a further luminaire design of a further luminaire and a further light effect of the further luminaire.

11. The method according to claim 10, wherein the generative-AI machine learning model is a text-conditional generative adversarial network or a text-to-image diffusion model conditioned to generate the synthesized image based on the first and second text descriptions generated using the machine learning model.

12. The method according to claim 10, wherein the method further comprises:
analyzing the synthesized image for (i) determining a further first saliency value for the luminaire design in the synthesized image, and (ii) determining a further second saliency value for the light effect in the synthesized image;
receiving a further user feedback on the synthesized image;
associating the further user feedback to the luminaire design and/or the light effect based on the further first and second saliency values.

13. The method according to claim 10, wherein the method further comprises:
generating a specification for the further luminaire design, and outputting the specification to a system or service for generating (or manufacturing) the further luminaire design.

14. A computer program product for a computing device, the computer program product comprising computer program code to perform the method of claim 1, when the computer program product is run on a processing unit of the computing device.

15. A controller for distinguishing whether user feedback on an image is associated with a luminaire design of a luminaire and/or a light effect of the luminaire, the controller configured to:
provide an image of a scene, said image comprising an environment, the luminaire, said luminaire having the luminaire design and the light effect of the luminaire in the environment;
analyze the image to (i) determine a first saliency value for the luminaire design in the image, and (ii) determine a second saliency value for the light effect in the image, wherein the second saliency value is different from the first saliency value;
receive the user feedback on the image;
associate the user feedback with the luminaire design and/or the light effect based on the first and second saliency values.
